(19) United States
(12) Patent Application Publication
(10) Pub. No.: US 2017/0153894 A1
(43) Pub. Date: Jun. 1, 2017

(54) APPARATUS AND METHOD FOR BRANCH PREDICTION

(71) Applicant: ARM LIMITED, Cambridge (GB)

(72) Inventors: Alexander Alfred HORNUNG, Cambridge (GB); Adrian Viorel POPESCU, Cambridge (GB)

(21) Appl. No.: 14/953,201

(22) Filed: Nov. 27, 2015

(51) Int. Cl. G06F 9/38; G06F 9/30

(52) U.S. Cl. CPC G06F 9/3806; G06F 9/30058

(57) ABSTRACT

An apparatus which produces branch predictions and a method of operating such an apparatus are provided. A branch target storage used to store entries comprising indications of branch instruction source addresses and indications of branch instruction target addresses is further used to store bias weights. A history storage stores history-based weights for the branch instruction source addresses and a history-based weight is dependent on whether a branch to a branch instruction target address from a branch instruction source address has previously been taken for at least one previous encounter with the branch instruction source address. Prediction generation circuitry receives the bias weight and the history-based weight of the branch instruction source address and generates either a taken prediction or a not-taken prediction for the branch. The reuse of the branch target storage to bias weights reduces the total storage required and the matching of entire source addresses avoids problems related to aliasing.

### TECHNICAL FIELD

The present disclosure relates to a data processing apparatus. More particularly, it relates to branch prediction in a data processing apparatus.

### BACKGROUND

A data processing apparatus which performs data processing operations in response to executed data processing instructions may be provided with branch prediction capability in order to predict whether a branch defined in a branch instruction will likely be taken or not. This capability allows a target instruction to be retrieved earlier from a target address, in particular before it is definitively known whether the branch will be taken not. This mitigates against the latency associated with the retrieval of the target instruction from the target address in memory.

One approach to branch prediction may be to combine relative weights stored in a number of tables to generate a combined value which, if it exceeds a threshold, causes the branch to be predicted and taken. One example of such a table is a bias table providing a prediction based on the address of the branch instruction. However, the limited space typically available for storing such tables can result in conflicts (aliasing), since several different branches can share the same entry.

It would be desirable to provide an improved technique for branch prediction.

### SUMMARY

Some embodiments provide an apparatus comprising: branch target storage to store entries comprising indications of branch instruction source addresses and indications of branch instruction target addresses, wherein the entries each further comprise a bias weight; history storage to store history-based weights for branch instruction source addresses, wherein a history-based weight is dependent on whether a branch to a branch instruction target address from a branch instruction source address has previously been taken for at least one previous encounter with the branch instruction source address; and prediction generation circuitry to receive the bias weight and the history-based weight of the branch instruction source address and to generate either a taken prediction or a not-taken prediction for the branch.

Some embodiments provide a method of branch target prediction in a data processing apparatus comprising the steps of: storing entries in branch target storage comprising indications of branch instruction source addresses and indications of branch instruction target addresses, wherein the entries each further comprise a bias weight; storing in history storage history-based weights for branch instruction source addresses, wherein a history-based weight is dependent on whether a branch to a branch instruction target address from a branch instruction source address has previously been taken for at least one previous encounter with the branch instruction source address; and receiving the bias weight and the history-based weight of the branch instruction source address and generating either a taken prediction or a not-taken prediction for the branch.

Some embodiments provide an apparatus comprising: means for storing entries comprising indications of branch instruction source addresses and indications of branch instruction target addresses, wherein the entries each further comprise a bias weight; means for storing history-based weights for branch instruction source addresses, wherein a history-based weight is dependent on whether a branch to a branch instruction target address from a branch instruction source address has previously been taken for at least one previous encounter with the branch instruction source address; and means for receiving the bias weight and the history-based weight of the branch instruction source address and for generating either a taken prediction or a not-taken prediction for the branch.

### BRIEF DESCRIPTION OF THE DRAWINGS

The present techniques will be described further, by way of example only, with reference to embodiments thereof as illustrated in the accompanying drawings, in which:

FIG. 1 schematically illustrates the apparatus of one embodiment;

FIG. 2 schematically illustrates a pipelined data processing apparatus in one embodiment;

FIG. 3 schematically illustrates the apparatus of one embodiment in which a global history value is used;

FIG. 4 schematically illustrates the apparatus of one embodiment in which a prediction is selected from one of two sources in dependence on a meta value stored in a branch target buffer; and

FIG. 5 shows a sequence of steps which are taken in one embodiment;

### DESCRIPTION OF EXAMPLE EMBODIMENTS

Some embodiments provide apparatus comprising: branch target storage to store entries comprising indications of branch instruction source addresses and indications of branch instruction target addresses, wherein the entries each further comprise a bias weight; history storage to store history-based weights for branch instruction source addresses, wherein a history-based weight is dependent on whether a branch to a branch instruction target address from a branch instruction source address has previously been taken for at least one previous encounter with the branch instruction source address; and prediction generation circuitry to receive the bias weight and the history-based weight of the branch instruction source address and to generate either a taken prediction or a not-taken prediction for the branch.

The present techniques recognise that increasing the size of a table in order to seek to avoid aliasing is undesirable because it requires greater area to be occupied in the apparatus, has higher power consumption, and may lower the maximum operating frequency of the apparatus. The present techniques also recognise that whilst less aliasing may be achieved by careful tuning of the indexing function into a table, it is typically nonetheless very difficult to avoid the fact that a small number of branches will still conflict. Storing the bias weight as an additional component of the entries in a branch target storage which already stores corresponding source and target addresses not only allows very efficient storage of these bias weights, but also due to the fact that the entire source address is matched means that the potential for aliasing is removed. For example in the context of a relatively small branch targets storage (such as a micro branch target buffer (μBTB)), which may only store say 64 separate entries, this allows 64 different bias weights to be efficiently stored and a conflict free “bi-modal” weight (i.e. that generated in the prediction generation circuitry) to be provided. By contrast using a standard (separate) bias table significantly more than 64 weights, and a well-tuned indexing function, would be required to achieve even near conflict-free prediction. The prediction generation circuitry can make use of the bias weight and history-based weight in a number of ways in dependence on, for example, the relative importance of these weights, their empirically found ability to make accurate branch predictions and so on.

In some embodiments the prediction generation circuitry is capable of combining the bias weight and the history-based weight to give a combined value and to generate either the taken prediction or the not-taken prediction for the branch in dependence on the combined value. Thus, rather than taking one of the bias weight and the history-based weight in order to generate the branch prediction, a combination of both is used, allowing the prediction to benefit from specific situations in which the bias weight proves better than the history-based weight in providing an accurate branch prediction, and vice versa.

The particular manner in which the bias weight and the history-based weight are combined may take a variety of forms, but in some embodiments the prediction generation circuitry comprises addition circuitry to add the bias weight and the history-based weight to produce the combined value as a sum and threshold circuitry responsive to the sum to generate the taken prediction if the sum exceeds a threshold value. Accordingly a perceptron-type predictor can be provided, and efficiently implemented in terms of the storage space required to support it.

Whilst the apparatus may make use of only one “bias table” (provided by the branch target storage and one history storage), in some embodiments the apparatus further comprises at least one further storage to store at least one further set of weights, wherein the at least one further storage is responsive to a function of at least one of: the branch instruction source address, a global history value, and path information to select a further weight from the at least one further set of weights, and the prediction generation circuitry is capable of combining the further weight with the bias weight and the history-based weight and of generating either the taken prediction or the not-taken prediction for the branch. The provision of more than one history storage in this manner can for example allow different weights to be selected as a function of different items of information or combinations thereof (such as partial addresses, global history, path history, and so on) and a more adaptable predictor is thus provided, since it can respond differently to a greater range of contexts for a given branch instruction.

In some embodiments the apparatus further comprises weight update circuitry responsive to an outcome of the branch to update the bias weight stored in the branch target storage for the branch instruction source address. This enables the branch prediction circuitry to provide a branch prediction which has been dynamically updated during normal operation to take into account the correctness of its previous branch predictions in that normal operation (rather than for example as defined by a pre-configuration before the normal operation began) which can improve the accuracy of further branch predictions which it provides.

The history-based weight may be selected from the history storage in a variety of ways, but in some embodiments the apparatus further comprises a global history storage to store a global history value for branches encountered and index generation circuitry to combine an at least partial branch instruction source address and the global history value to generate a history index used to select the history-based weight from the history storage. For example the global history storage may be provided in the form of a global history register. Such embodiments provide a branch prediction mechanism which is very efficient in terms of the storage capacity it requires, which is nonetheless able to generate its branch prediction both in dependence on global branch prediction outcomes and on specific branch instructions (i.e. their source addresses) and therefore with good accuracy.

The index generation circuitry may combine the at least partial branch instruction source address and the global history value in a variety of ways but in some embodiments the index generation circuitry comprises a hash function to generate the history index.

Whilst the bias weight may be the only “additional” information which is stored in the branch target storage, the present techniques recognise that the efficiency associated with adding to the entries stored in the branch targets storage may find further application. For example in some embodiments the entries each further comprise a selection value and wherein the prediction generation circuitry further comprises selection circuitry responsive to the selection value to generate either the taken prediction or the not-taken prediction for the branch based on either the bias weight or the history-based weight. Accordingly this “meta data” provides one mechanism for the branch prediction to be made based on the particular type of weight which has been found to be useful for this entry (i.e. this branch target address).

In some embodiments the apparatus comprises more than one history storage to store at least one further set of history-based weights, and further comprises history combination circuitry to pass a single history-based weight to the prediction generation circuitry in dependence on outputs of the more than one history storage. Thus, whilst more than one history storage can be provided, only a single history-based weight can nonetheless be passed to the prediction generation circuitry, enabling a simple configuration of the prediction generation circuitry which thus only receives two input values: the bias weight from the branch targets storage and the single history-based weight.

Whilst the history-based weights may take a variety of forms, for example as weights whose possible values exhibit a relatively high degree of granularity (for example in one particular embodiment they could range from −32 to +32), the apparatus may benefit from these weights being provided in the form of “takenness” indications (counter values), for example comprising the four possibilities: strongly not taken, weakly not taken, weakly taken, and strongly taken. These can be efficiently represented by a two-bit value. These kinds of history-based weights can for example be combined to produce the single history-based weight by an efficient mechanism such as a majority decision. Hence in some embodiments the at least one further set of history-based weights are branch prediction counter values and the history combination circuitry is capable of generating the single history-based weight on a majority basis from the branch prediction counter values.

In some embodiments the apparatus comprises multiple pipeline stages and the apparatus further comprises instruction fetch circuitry in a pipeline stage after the prediction generation circuitry, wherein the instruction fetch circuitry is responsive to the taken prediction generated by the prediction generation circuitry to retrieve an instruction stored at the branch instruction target address. The efficient storage, and rapid retrieval from that storage, of the bias weight is more relevant to an earlier pipeline stage since once a later pipeline stage has been reached, further context and relevant information may already be available on which to base a branch prediction. In this context such embodiments may implement the present techniques in an earlier, simpler branch predictor (such as a μBTB), rather than later, more complex branch predictor (such as a branch target address cache (BTAC)).

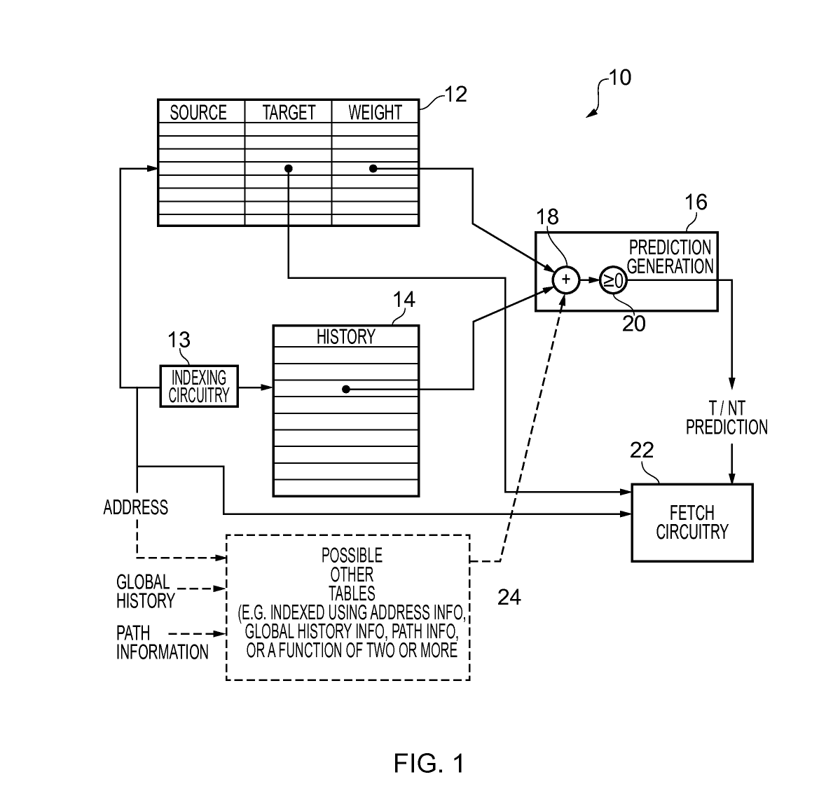

Some particular embodiments will now be described with reference to the figures. FIG. 1 schematically illustrates an apparatus in one embodiment. The apparatus 10 comprises branch target storage 12, indexing circuitry 13, history storage 14 and prediction generation circuitry 16. The branch target storage 12 in this example embodiment is a μBTB which stores indications of source and target addresses for branch instructions, where a received full address is matched against the source addresses stored, and as can be seen in FIG. 1 each entry further comprises a weight, this being a bias weight which when a hit is found in the μBTB 12 is passed to the prediction generation circuitry 16. Prediction generation circuitry 16 also receives an input from the history storage 14, which holds entries which each have a history-based weight, the value of which is dependent on the branch outcome when this branch source instruction was previously encountered. The entry in the history storage 14 is selected by the indexing circuitry 13 on the basis of the address. The prediction generation circuitry 16 comprises summation circuitry 18, which sums the two weights it receives and passes this sum value to the threshold circuitry 20, which in this example compares this sum value to 0 and where the sum value is greater than or equal to 0 the prediction generation circuitry outputs a “taken” (T) prediction for this branch and otherwise generates a “not taken” (NT) prediction for this branch. The prediction is received by fetch circuitry 22, which then retrieves an appropriate next instruction from memory, i.e. the target address stored in the branch target storage for a T prediction and the subsequent instruction in program order for an NT prediction. Accordingly, the prediction generation circuitry 16 is able to act in the manner of a perceptron predictor, but wherein the bias weight is received from the entry in the branch target buffer, which is should be noted provides the prediction only based on a function of the address (effectively providing a bimodal prediction). The fact that the branch target buffer stores indications of full source addresses means that the above mentioned problems with conflicts/aliasing are avoided. Moreover, the existing functionality of the branch target buffer 12 (not explicitly illustrated in FIG. 1 for clarity but this will be understood by one or ordinary skill in the art to include mechanisms for looking up an address and generating appropriate outputs when hits or misses are established) means that this (bias table) storage can be provided with very little additional storage or control circuitry being required on top of that which would already be provided for the branch target buffer. The dashed lines in FIG. 1 schematically illustrate that the prediction generation circuitry 16 may also receive one or more further weights from other tables 24 which may also be indexed on the basis of the address, or for example on the basis of global history information, path information and so on, or a function of any two or more of these pieces of information.

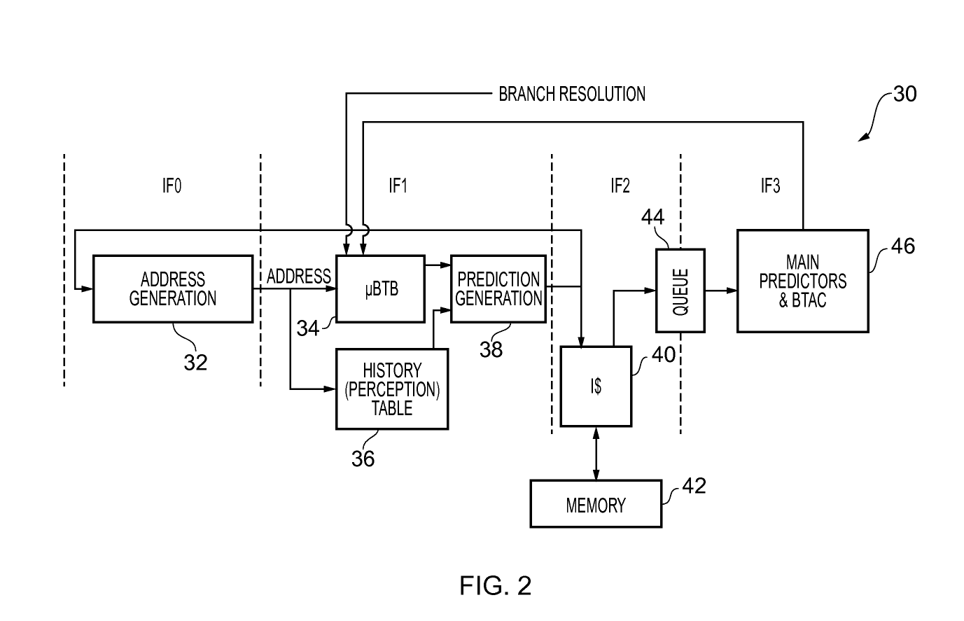

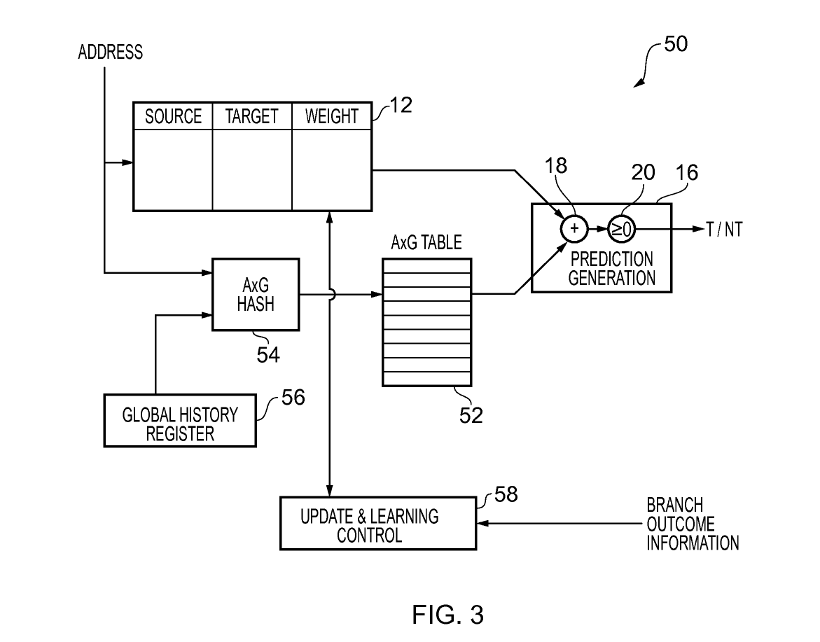

FIG. 2 schematically illustrates one example wider context of the apparatus, in a data processing apparatus 30 which has a pipelined structure. Four pipeline stages (IF0-3) are shown in FIG. 2, which form part of the instruction fetch (IF) functionality of a data processing apparatus. The first component shown in IF0 is the address generation circuitry 32 which generates a sequence of addresses, typically based on an incrementing program counter, which give the storage locations of corresponding program order instructions. However, as will be clear from the context of the present techniques, when a branch instruction is encountered incremental instruction addresses are not be followed in the case where a branch instruction causes the program flow to jump to a different (non-sequential) point in the program order instructions. In stage IF1 the apparatus is provided with a μBTB 34, a history (perceptron) table 36 and prediction generation circuitry 38, which can for example have a configuration as was described above in more detail with reference to the embodiment of FIG. 1 or as will be described in more detail below with reference to the example embodiment of FIG. 3. The T/NT prediction generated by the prediction generation circuitry 38 causes (in stage IF2) the required address to be passed to the instruction cache 40, such that it can be checked if the relevant predicted target instruction is already stored therein. If it is not then, in a manner in which one of ordinary skill in the art will be familiar, a request for this instruction is passed out further into the memory hierarchy, and ultimately if necessary out to the memory 42. Once retrieved, the instruction is stored in queue 44 at the beginning of stage IF3, and is then received by the main predictors and branch target address cache (BTAC) 46. These predictors provide feedback to the μBTB so that its content can be updated on the basis of the output of those predictors (which, coming later in the pipeline, have more information available and are therefore able to predict more accurately). Feedback can also be provided from a still later stage in the pipeline about how the branch was in fact resolved.

FIG. 3 schematically illustrates an apparatus in one embodiment. It will be appreciated from a comparison with FIG. 1 that this embodiment is similar and indeed the branch target buffer 12 and the prediction generation circuitry 16 are identical and have been given the same reference numerals including those of the subcomponents of the prediction generation circuitry. However, in the embodiment shown in FIG. 3 the history storage is differently configured, in particular being provided by a table 52, which is indexed into via a hash value generated by hash generation circuitry 54, which generates the hash value on the basis of (some bits of) the address received and a value held in a global history register 56. Hence, in operation an address received is looked up in the branch target buffer 12 to see if a corresponding indication of a branch instruction source address is stored therein as well as being passed to the Address×Global (A×G) hash circuitry 54 to generate the hash value from this address and the value stored in the global history register 56 to index into the A×G table 52. When a hit occurs in the branch target buffer 12 the corresponding weight of the relevant entry is read out and passed to the addition circuitry 18 of the prediction generation circuitry 16 and the entry identified by the hash index and the A×G table 52 is also passed to the addition circuitry 18 of the prediction generation circuitry 16 of the prediction generation circuitry 16. These respective weights are summed and the sum values passed to the threshold circuitry 20 which, if the sum value equals or exceeds 0, generates the taken (T) indication and otherwise generates the not taken (NT) indication. Hence in this embodiment the “perceptron predictor” provided thus combines the bias value from the weight entry of the branch target buffer 12 with the history value from the A×G table 52 to generate its prediction. Note also that FIG. 3 schematically illustrates update and learning control circuitry 58 which receives information relating to the outcome of branches defined by branch instructions (as mentioned above this could either be from a later, more accurate predictor, or indeed from the ultimate branch resolution outcome). On this basis it can update the weight held for the relevant entry in the branch target buffer 12, typically this comprising increasing the weight in the event that the prediction was correct and decreasing the weight when the prediction was incorrect. The predictor is thus able to learn and improve its predictive capability with respect to recently encountered branch instructions. It should be noted that although the update and learning control circuitry 58 is only explicitly illustrated in the example embodiments shown in FIG. 3, it is equally applicable to any of the apparatus embodiments described herein.

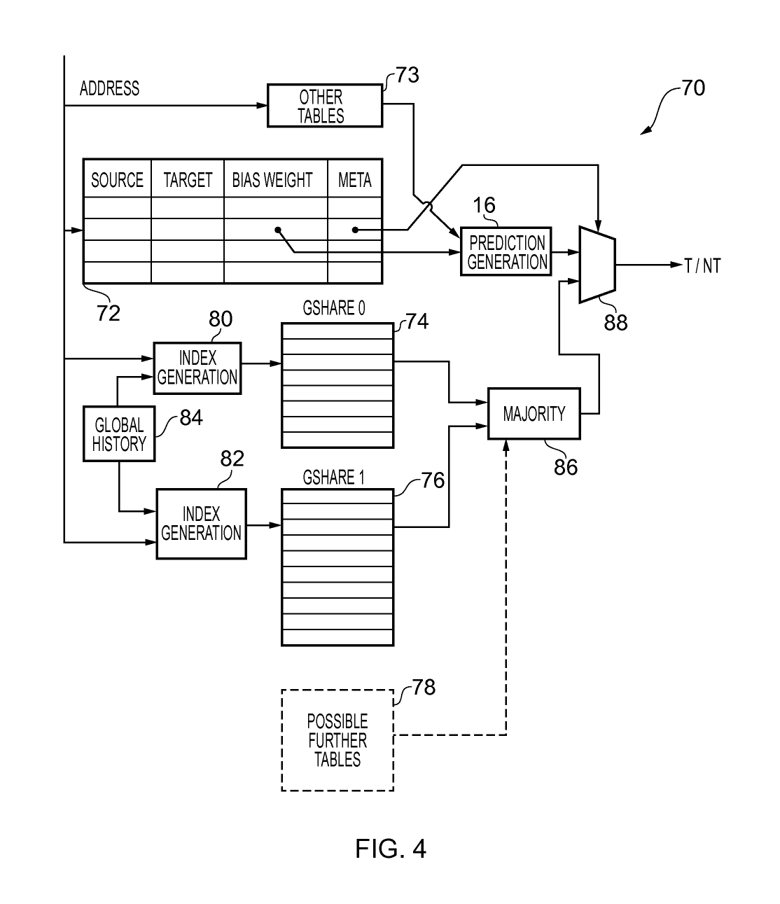

FIG. 4 schematically illustrates a further example apparatus embodiment 70. Here the branch target buffer 72 stores indications of branch instruction source addresses, indications of branch instruction target addresses, bias weights and metadata in each of its entries. The metadata is used to select between the output of the prediction generation circuitry 16 (configured as described above, and receiving one or more further inputs to combine from the other tables 73) and a takenness value generated on the basis of a combination of several history tables 74, 76, and 78. Note that history table 78 is illustrated (by means of the dashed lines) as a possibility in this embodiment which could comprise one or more further tables, which could be history based or based on another relevant item of information such as branch instruction source address (only) or path information. The history tables 74 and 76 in FIG. 4, also labelled Gshare0 and Gshare1 are indexed into by an index generated by the respective index generation circuitry 80 and 82, where each of these index generation circuitry instances generates the index on the basis of the received address and the global history value retrieved from storage 84 (e.g. a global history register). Gshare0 74 and Gshare1 76 store the takenness values in this example embodiment using a 2-bit value, the four possibilities of which indicate strongly not taken, weakly not taken, weakly taken, and strongly taken. The takenness values are passed to majority evaluation circuitry 86, which generates a majority output on the basis of the inputs it receives. Accordingly, the selection circuitry 88 in FIG. 4, in the form of a multiplexer, receives a N/NT predication from the prediction generation circuitry 16 and a (majority evaluated) takenness value received from the majority evaluation circuitry 86. The output of the multiplexer 88 is selected on the basis of the metadata stored in the branch target buffer 72 for this entry.

Note that when a new entry is allocated into the branch target buffer (in any of the example embodiments described herein) the bias weight (and any similar values) are set to a default value. This function is provided by the update circuitry 58 described above (though not explicitly shown in FIG. 4). The bias weight on allocation is biased towards taken (T) since there is a general bias towards only allocating taken branches into the BTB in the first place. The same principle applies to the meta value, which acts as a sort of selector value. The meta value however can be initialized a little differently if required, for example based on some feedback from the main predictor. Note that if a later, main predictor is a GSkew predictor (like the tables 74, 76, and 78 combining in a majority decision such as in item 86), i.e. one that has that sort of meta prediction arrangement itself, it may be viewed as more useful to assuming that, if the main predictor is better off (for this branch) picking, say, the majority prediction, it is likely that the branch target buffer would also be better off using the same majority decision mechanism, at least to start with. Similarly, if the main predictor is a perceptron predictor (like items 72, 73 and 16) and it turns out that the biggest contribution (i.e. the largest weight) to the final decision is the bias weight, it is probably appropriate to initialize the bias weight in the BTB to something above average. These are implementation decisions which depend on the particular performance desired. Another possibility would be to write the last-known bias weight and any other required parts of the BTB entry into the instruction cache, next to the instruction, when the branch gets evicted from the BTB. Then when the branch gets reallocated, provided it was not evicted from the instruction cache, it could pick up the last setting it used before being evicted.

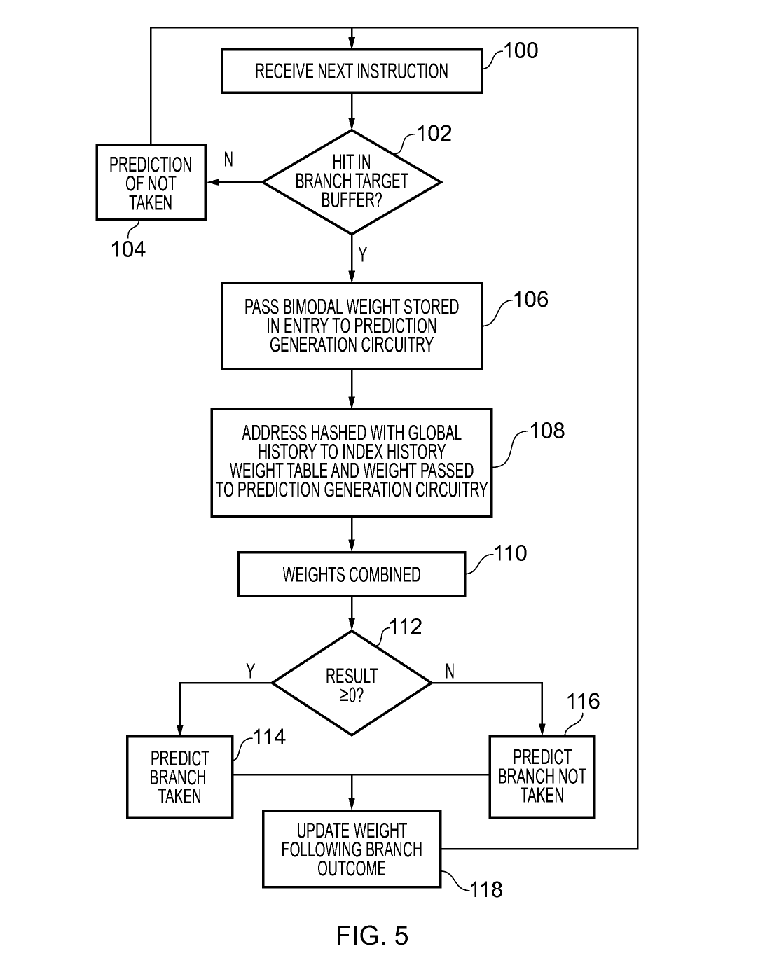

FIG. 5 shows a sequence of steps which are carried out in a method of one embodiment when operating an apparatus such as, but not limited to, those described above with reference to FIGS. 1 to 4. The flow can be considered to begin at step 100, where the next instruction is received and at step 102 it is determined if this instruction address hits in the branch target buffer. If a miss occurs then the apparatus behaves as though a not taken prediction has been made (step 104) in that the next sequential instruction address will be fetched. Note that this miss in the BTB may cause a new entry to be allocated—once it is later determined that this was in fact a branch instruction—for example from information available to the above-mentioned main predictors later in the pipeline. This allocation decision, the victim selection, and so on can be performed in a manner in which one of ordinary skill is familiar. When a hit does occur then the flow proceeds to step 106 where the bimodal (bias) weight stored in the entry is passed to the prediction generation circuitry. Then at step 108, the received address is also hashed with the global history in order to index into the history weight table (A×G table 52 in the example of FIG. 3) and the weight read out of the history weight table is passed to the prediction generation circuitry. Within the prediction generation circuitry, at step 110, the weights from the BTB and the history table are combined and it is determined at step 112 if this resulting value is greater than or equal to 0. If it is then at step 114 the branch is predicted as taken (and the next instruction is fetched from the stored target address), whereas if the result value is less than 0, then at step 116 the branch is predicted as not taken and the next instruction is retrieved from the sequentially next instruction address. Step 118 indicates the updating of the weight stored in the BTB being updated on the basis of the outcome of the branch (e.g. the branch resolution or just on the basis of a later main predictor) and the flow returns to step 100.

By way of brief overall summary an apparatus which produces branch predictions and a method of operating such an apparatus are provided. A branch target storage used to store entries comprising indications of branch instruction source addresses and indications of branch instruction target addresses is further used to store bias weights. A history storage stores history-based weights for the branch instruction source addresses and a history-based weight is dependent on whether a branch to a branch instruction target address from a branch instruction source address has previously been taken for at least one previous encounter with the branch instruction source address. Prediction generation circuitry receives the bias weight and the history-based weight of the branch instruction source address and generates either a taken prediction or a not-taken prediction for the branch. The reuse of the branch target storage to bias weights reduces the total storage required and the matching of entire source addresses avoids problems related to aliasing.

In the present application, the words “configured to . . . ” or “arranged to” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” or “arranged to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

We claim:

1. Apparatus comprising:
branch target storage to store entries comprising indications of branch instruction source addresses and indications of branch instruction target addresses, wherein the entries each further comprise a bias weight;
history storage to store history-based weights for branch instruction source addresses, wherein a history-based weight is dependent on whether a branch to a branch instruction target address from a branch instruction source address has previously been taken for at least one previous encounter with the branch instruction source address; and
prediction generation circuitry to receive the bias weight and the history-based weight of the branch instruction source address and to generate either a taken prediction or a not-taken prediction for the branch.

2. The apparatus as claimed in claim 1, wherein the prediction generation circuitry is capable of combining the bias weight and the history-based weight to give a combined value and to generate either the taken prediction or the not-taken prediction for the branch in dependence on the combined value.

3. The apparatus as claimed in claim 2, wherein the prediction generation circuitry comprises addition circuitry to add the bias weight and the history-based weight to produce the combined value as a sum and threshold circuitry responsive to the sum to generate the taken prediction if the sum exceeds a threshold value.

4. The apparatus as claimed in claim 1, further comprising at least one further storage to store at least one further set of weights, wherein the at least one further storage is responsive to a function of at least one of: the branch instruction source address, a global history value, and path information to select a further weight from the at least one further set of weights,
and the prediction generation circuitry is capable of combining the further weight with the bias weight and the history-based weight and of generating either the taken prediction or the not-taken prediction for the branch.

5. The apparatus as claimed in claim 1, further comprising weight update circuitry responsive to an outcome of the branch to update the bias weight stored in the branch target storage for the branch instruction source address.

6. The apparatus as claimed in claim 1, further comprising a global history storage to store a global history value for branches encountered and index generation circuitry to combine an at least partial branch instruction source address and the global history value to generate a history index used to select the history-based weight from the history storage.

7. The apparatus as claimed in claim 6, wherein the index generation circuitry comprises a hash function to generate the history index.

8. The apparatus as claimed in claim 1, wherein the entries each further comprise a selection value and wherein the prediction generation circuitry further comprises selection circuitry responsive to the selection value to generate either the taken prediction or the not-taken prediction for the branch based on either the bias weight or the history-based weight.

9. The apparatus as claimed in claim 8, comprising more than one history storage to store at least one further set of history-based weights, and further comprising history combination circuitry to pass a single history-based weight to the prediction generation circuitry in dependence on outputs of the more than one history storage.

10. The apparatus as claimed in claim 9, wherein the at least one further set of history-based weights are branch prediction counter values and the history combination circuitry is capable of generating the single history-based weight on a majority basis from the branch prediction counter values.

11. The apparatus as claimed in claim 1, wherein the apparatus comprises multiple pipeline stages and the apparatus further comprises instruction fetch circuitry in a pipeline stage after the prediction generation circuitry, wherein the instruction fetch circuitry is responsive to the taken prediction generated by the prediction generation circuitry to retrieve an instruction stored at the branch instruction target address.

12. A method of branch target prediction in a data processing apparatus comprising the steps of:
storing entries in branch target storage comprising indications of branch instruction source addresses and indications of branch instruction target addresses, wherein the entries each further comprise a bias weight;
storing in history storage history-based weights for branch instruction source addresses, wherein a history-based weight is dependent on whether a branch to a branch instruction target address from a branch instruction source address has previously been taken for at least one previous encounter with the branch instruction source address; and
receiving the bias weight and the history-based weight of the branch instruction source address and generating either a taken prediction or a not-taken prediction for the branch.

13. Apparatus comprising:
means for storing entries comprising indications of branch instruction source addresses and indications of branch instruction target addresses, wherein the entries each further comprise a bias weight;
means for storing history-based weights for branch instruction source addresses, wherein a history-based weight is dependent on whether a branch to a branch instruction target address from a branch instruction source address has previously been taken for at least one previous encounter with the branch instruction source address; and
means for receiving the bias weight and the history-based weight of the branch instruction source address and for generating either a taken prediction or a not-taken prediction for the branch.
